(19) United States
(12) Patent Application Publication
(10) Pub. No.: US 2024/0204297 A1
(43) Pub. Date: Jun. 20, 2024

(54) AIRCRAFT BATTERY COOLING AND FIRE SUPPRESSION

(71) Applicant: Lockheed Martin Corporation, Bethesda, MD (US)

(72) Inventors: Erez Eller, Oakville, CT (US); Timothy F. Lauder, Oxford, CT (US)

(21) Appl. No.: 18/081,164

(22) Filed: Dec. 14, 2022

(51) Int. Cl. H01M 10/6568; H01M 10/48; H01M 10/63; H01M 50/317; H01M 50/383

(52) U.S. Cl. CPC H01M 10/6568; H01M 10/482; H01M 10/486; H01M 10/63; H01M 50/317; H01M 50/383; H01M 10/613

(57) ABSTRACT

Systems and methods for providing cooling and fire suppression for battery modules of an aircraft. One embodiment described herein provides an aircraft including a plurality of battery modules and a battery thermal management system. Each battery of the plurality of battery modules includes a housing. The battery thermal management system includes a storage vessel containing a cooling propellant, a conduit fluidly coupling the storage vessel to an interior of the housing of each of the plurality of battery modules, a vessel valve controlling a flow rate of the cooling propellant from the storage vessel to the conduit, and a venting system. The venting system includes one or more nozzles extending to an exterior of the aircraft and in fluid communication with the interior of the housing of each of the plurality of battery modules. The one or more nozzles direct the cooling propellant to the exterior of the aircraft.

### FIELD OF INVENTION

Embodiments described herein relate to a battery thermal management system for an aircraft, and, in particular, a battery thermal management system for providing cooling and fire suppression for battery modules utilized during a landing operation.

### SUMMARY

Hybrid propulsion aircrafts use an engine to generate mechanical power, which is converted to electrical power and then back into mechanical power at one or more rotors or propellers. To provide backup power during engine failure, these aircrafts may include a battery, which can be used to perform a controlled landing. Such a backup battery may be used for a short duration of time, such as, for example, approximately 30 to 40 seconds, but may provide high power output during this duration. The short-duration but high-power nature of the backup battery creates different cooling and fire suppression requirements than batteries used in other hybrid or electric vehicle applications, which often provide lower power for longer durations. Also, adding cooling systems and fire suppression systems to the aircraft, such as, for example, a fan for providing forced air or a liquid cooling system, increases a weight of the aircraft.

To address these and other technical problems, embodiments described herein provide a battery thermal management system for a battery installed on an aircraft, such as, for example, a backup battery providing power for performing a controlled landing of the aircraft. As described below, the battery thermal management system allows the battery backup to provide high-power output for a short duration, such as during a controlled powered landing, by providing cooling, fire suppression, or a combination thereof while limiting an amount of additional weight imposed on the aircraft. In fact, in some embodiments, the battery thermal management system allows a weight of the battery to be reduced. For example, the cooling, fire suppression, or both provided by the battery thermal management systems may allow a lighter weight casing or housing to be used for the battery, individual battery modules of the battery, or both.

In some embodiments, the battery thermal management system includes a storage vessel, such as a pressurized vessel storing a propellent. The propellant may include an inert gas, such as, for example, nitrogen or carbon dioxide, compressed to a liquid state. Expansion of the gas during discharge of the storage vessel results in gas cooling, which, as compared to liquid cooling systems, imposes a reduced weight on the aircraft. Also, the propellant may eliminate the need for a fan or other equipment to move cooled air through the battery. In some embodiments, the propellant, when discharged from the vessel provides cooling, fire suppression, or both. For example, in some embodiments, the pressure vessel includes an inert gas that provides gas cooling when expelled but also functions as a fire suppressant, such as for example, nitrogen or carbon dioxide. In other embodiments, the pressure vessel includes an inert gas that provides gas cooling when expelled, wherein the inert gas is combined with a fire suppressant, such as, for example, copper or one or more other substances designed to extinguish lithium battery fires. In other embodiments, the battery thermal management system includes multiple storage vessels. For example, the battery thermal management system may include a first storage vessel storing a coolant propellant and a second storage vessel storing a fire suppressant. In this embodiment, one or more valves may be used to control (for example, independently) the discharge flow rate of each storage vessel, wherein, in some embodiments, the output of each storage vessel is delivered to the battery using common pathways, which provides further weight reductions as compared to installing separate cooling and fire suppression systems in the aircraft.

In some embodiments, a system valve regulates discharge of the propellant from the storage vessel to set a desired flow rate for cooling, fire suppression, or both. The flow rate can be regulated to produce desired sustained temperature changes over a discharge cycle of the battery due to the decompression of the stored propellant. The battery thermal management system may also include a plurality of module valves, wherein each module valve is associated with a battery module of the battery. In particular, the module valves may be positioned in series with the system valve and in parallel to each other, wherein each module valve controls an amount of discharged propellant delivered to one or more battery modules included in the battery. The flow rate set for a particular module valve may be based on a current operating state of the individual battery module associated with the module valve or other battery modules and may independent adjustable to provide a particular flow rate (and, optionally, a different substance) to each battery module as needed independent of the flow rate or substance provided to other battery modules. The parallel flow paths for each battery module and the selective valving for an individual module reduces an amount of propellant, fire suppressant, or both used by the system, which reduces the amount of propellant, fire suppressant, or both required to be installed in the aircraft and the associated weight.

For example, in some embodiments, the module valves are used to direct a fire suppressant to a battery module experiencing a fire or where a fire is imminent while preventing the fire suppression substance from reaching other battery modules. For example, in some embodiments, the fire suppression substance may damage a battery module, and, accordingly, the module valves may be controlled to limit what battery modules are exposed to the fire suppressant. Similarly, in some embodiments, a cooling propellant may be supplied through the system valve to all battery modules, but the module valve associated with each battery module may be controlled, independent of other module valves, to provide a flow rate tailored to the battery module.

Baffles inside the battery modules may direct flow through gaps between cells of each battery module. Also, in some embodiments, a casing for a battery module, a cell of a battery module, or both includes integrated cooling fins to increase the effectiveness of the propellant and provide thermal mass. The cooling fins may include corrugated panels, such as, for example, steel panels, to provide coolant path gaps, structure, and surface area for heat transfer.

The battery thermal management system may also include a venting system. The venting system allows propellant, fire suppressant, or any substance passing through the battery to be expelled out of the battery and, in some embodiments, out of the aircraft. For example, the venting system may include one or more pressure-mounted plugs or panels on an exterior surface of the aircraft (for example, flush with an exterior surface or skin of the aircraft). As pressure builds in a battery module, the plugs or panels are blown-out, which creates a passage for the propellant, fire suppressant, or any substance flowing through the battery, such as, for example, gases created by the battery modules, to exit the aircraft. When the plugs or panels are blown-out and expose one or more openings to an exterior of the aircraft, one or more nozzles may be positioned with respect to the exposed openings to direct existing substances away from the outer skin of the aircraft. Accordingly, the venting system selectively permits fluid communication between the battery modules and the exterior of the aircraft.

To automatically control the valves and associated flow rates, the battery thermal management system may include one or more sensors positioned within the battery modules to detect a temperature, a fire, or both. Signals from the sensors indicating high temperature or fire may be provided to a controller configured to process the signals and control the valves according. For example, when a detected temperature exceeds a particular threshold, the controller may be configured to automatically change a position of one or more valves to increase an amount of gas cooling provided by the propellant. Similarly, when a fire is detected, the controller may be configured to automatically change a position of one or more valve to direct a fire suppressant to one or more battery modules where the fire was detected. In some embodiments, a thermo-mechanical system is used in place of or in combination with such a controller. The thermo-mechanical system may include one or more components that have physical properties that respond to temperature changes, such as, for example, wires that melt when exposed to certain temperatures or components that deform when exposed to certain temperatures. These physical responses are configured to initiate a change in position of at least one valve.

An operating state of the battery thermal management system may be indicated to a pilot or operator of the aircraft on one more instrument panels or displays in the aircraft or remote from the aircraft. The operating state may indicate whether the battery thermal management system is operating (for example, indicating that power is being supplied by the battery), a detected temperature, when a fire is detected in a particular battery module, a health of the system (for example, bottle pressure, a status or position of one or more of the valves included in the system or whether one or more valve passed one or more safety, or maintenance checks). In some embodiments, the health of the system is checked as part of a preflight system check.

For example, one embodiment described herein provides an aircraft including a plurality of battery modules and a battery thermal management system. Each battery of the plurality of battery modules includes a housing. The battery thermal management system includes a storage vessel containing a cooling propellant, a conduit fluidly coupling the storage vessel to an interior of the housing of each of the plurality of battery modules, a vessel valve controlling a flow rate of the cooling propellant from the storage vessel to the conduit, and a venting system. The venting system includes one or more nozzles extending to an exterior of the aircraft and in fluid communication with the interior of the housing of each of the plurality of battery modules. The one or more nozzles direct the cooling propellant to the exterior of the aircraft.

Another embodiment described herein provides a battery thermal management system for a plurality of battery modules within an aircraft. The battery thermal management system includes a storage vessel containing a cooling propellant, a conduit fluidly coupling the storage vessel to the plurality of battery modules, and a vessel valve controlling a flow rate of the cooling propellant from the storage vessel to the plurality of battery modules through the conduit. The battery thermal management system includes a sensor configured to monitor a condition of one or more of the plurality of battery modules, a venting system configured to selectively permit fluid communication between the plurality of battery modules and an exterior of the aircraft, and a controlling communicatively coupled to the vessel valve and the sensor. The controller is configured to control the vessel valve based on the condition of the one or more of the plurality of battery modules.

Another embodiment described herein provides a method of managing a plurality of battery modules aboard an aircraft. The method includes actuating, with a controller, a first vessel valve to an open position, the first vessel valve in fluid communication with a first storage vessel containing a cooling propellant and the plurality of battery modules through a conduit, and monitoring, with the controller, a temperature corresponding to one or more of the plurality of battery modules. The method includes actuating, with the controller in response to the temperature of a first battery module of the plurality of battery modules exceeding a predetermined temperature, a first module valve associated with the first battery module and in fluid communication with the first vessel valve to a first position, the first module valve independently controllable from a second module valve associated with a second battery module of the plurality of battery modules. The method includes detecting, with the controller, a fire in the second battery module of the plurality of battery modules, and in response to detecting the fire, actuating, with the controller the first module valve to a closed position, and actuating, with the controller, a second vessel valve to an open position, the second vessel valve in fluid communication with a second storage vessel containing a fire suppressant and the plurality of battery modules through the conduit.

Other aspects will become apparent by consideration of the detailed description and accompanying drawings.

### BRIEF DESCRIPTION OF THE DRAWINGS

FIG. 1 illustrates a tilt wing aircraft according to an example embodiment.

FIG. 2 illustrates a power generation and distribution system of the tilt wing aircraft of FIG. 1 according to an example embodiment.

FIGS. 3A-3B illustrates a battery module included in the tilt wing aircraft of FIG. 1 according to an example embodiment.

FIGS. 4A-4B illustrate an expansion nozzle included in the battery module of FIGS. 3A-3B according to an example embodiment.

FIG. 5 illustrates a battery thermal management system of the tilt wing aircraft of FIG. 1 according to an example embodiment.

FIG. 6 illustrates an expulsion nozzle of the battery thermal management system of FIG. 5 according to an example embodiment.

FIG. 7 illustrates a control system of the battery thermal management system of FIG. 5 according to an example embodiment.

FIG. 8 illustrates a method performed by the control system of FIG. 7 for controlling one or more valves of the battery thermal management system of FIG. 5 to provide a cooling propellant to a battery module according to an example embodiment.

FIG. 9 illustrates a method performed by the control system of FIG. 7 for controlling one or more valves of the battery thermal management system of FIG. 5 to provide a fire suppressant to a battery module according to an example embodiment.

### DETAILED DESCRIPTION

Before any embodiments are explained in detail, it is to be understood that the embodiments described herein are provided as examples and the details of construction and the arrangement of the components described herein or illustrated in the accompanying drawings should not be considered limiting. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and data exchanges may be performed using any known means including direct connections, wireless connections, and the like.

It should be noted that a plurality of hardware and software-based devices, as well as a plurality of different structural components may be utilized to implement the embodiments described herein or portions thereof. In addition, it should be understood that embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects described herein may be implemented in software (stored on non-transitory computer-readable medium) executable by one or more processors. As such, it should be noted that a plurality of hardware and software-based devices, as well as a plurality of different structural components may be used to implement the embodiments described herein. For example, “controller” described in the specification may include one or more processors, one or more memory modules including non-transitory computer-readable medium, one or more input/output interfaces, and various connections (for example, a system bus) connecting the components.

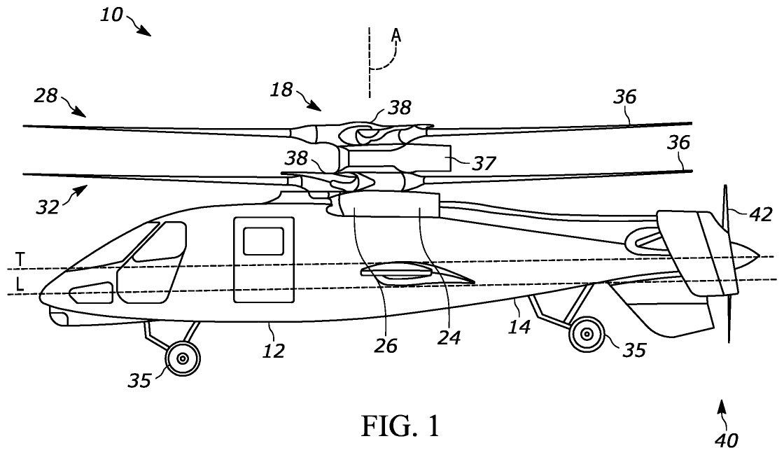

Referring now to the figures, FIG. 1 illustrates a tilt wing aircraft 10 according to an example embodiment. The aircraft 10 includes an airframe 12 with an extending tail 14. A pair of main rotor assemblies 18 are located at the airframe 12. The main rotor assemblies 18 each include a plurality of blades 22 secured to a rotor hub. The main rotor assemblies 18 are driven by a power source, for example, one or more engines 24, via gearboxes 26, one or more batteries powering one or more motors, or a combination thereof. Additionally, the aircraft 10 may include landing gear assemblies 35 (e.g., landing gear actuators) extending from below the airframe 12. The illustrated aircraft 10 includes two rear landing gear assemblies 35 (right landing gear not shown in FIG. 1) and a front landing gear assembly 35. In some embodiments, the landing gear assemblies 35 may be retractable. The landing gear assemblies 35 include wheels and struts, which may support the aircraft 10 when landed and enable the aircraft 10 to travel when on the ground. The aircraft 10 includes a cabin 28 where an operator may be located during operation of the aircraft 10.

While FIG. 1 illustrates an example tilt wing aircraft, systems and methods described herein may be used in different types of aircrafts. For example, systems and methods described herein may be utilized in hybrid or electrically powered aircraft, whether a fixed wing aircraft, a rotorcraft aircraft, a Vertical Takeoff Or Landing aircraft, or other suitable aircraft or air vehicle implementing an electronic power supply for primary or backup power.

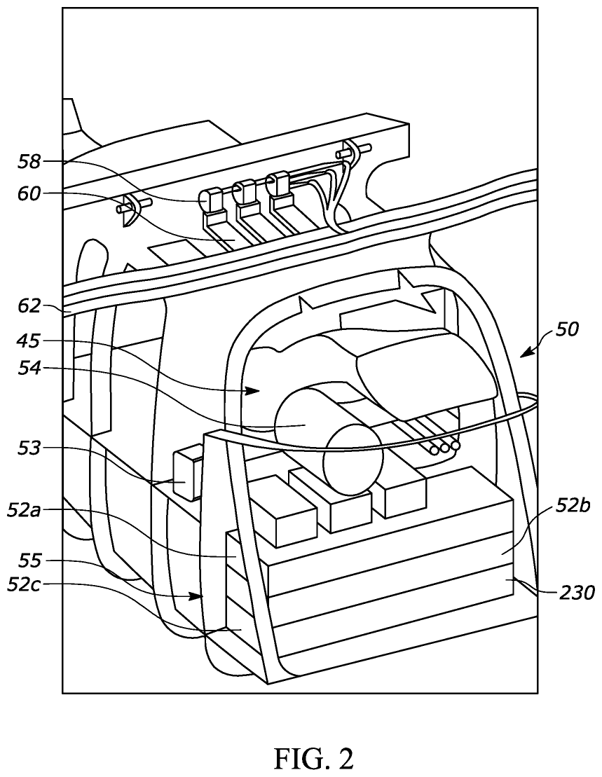

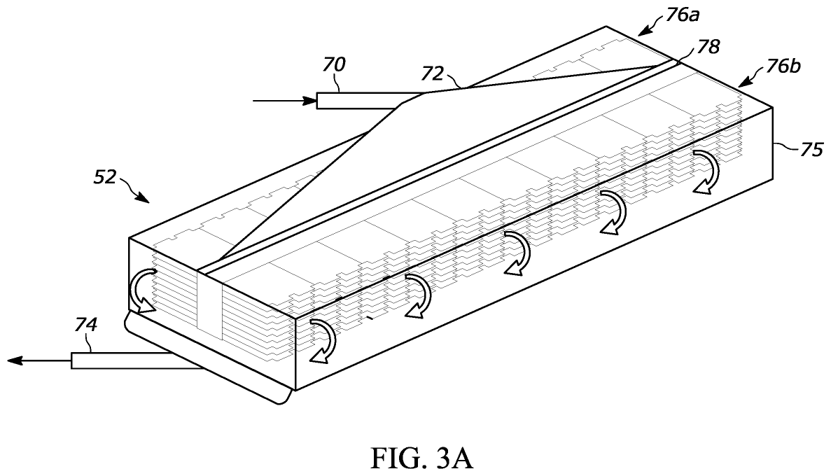

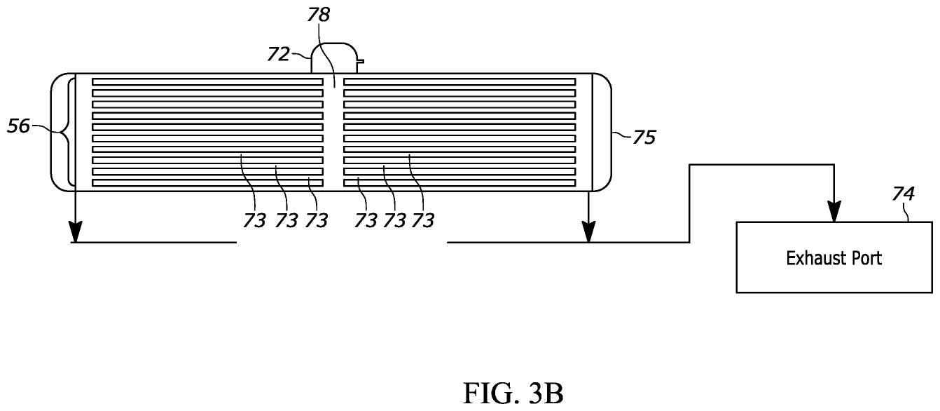

FIG. 2 illustrates a power supply system 50 of the aircraft 10 according to some embodiments. The power supply system 50 is configured to provide power to various systems of the aircraft, including, for example, the main rotor assemblies 18 as shown in FIG. 1, rotor actuators, control surface actuators, and the landing gear actuators 35. The power supply system 50 includes a battery 55, which includes a plurality of battery modules 52. The power supply system 50 also includes an engine driven generator 54, such as a generator driven by an internal combustion engine (not shown). The battery 55 and the engine driven generator 54 are housed in an interior 45 (e.g., a cabin, a fuselage, and the like) of the aircraft 10. The engine driven generator 54 provides power to the aircraft 10 during normal operation. The battery 55 is configured to provide power to the aircraft 10 to perform a powered controlled landing, such as, for example, when the engine driven generator 54 fails or is otherwise underperforming. In the illustrated example, the battery 55 includes a first battery module 52a, a second battery module 52b, and a third battery module 52c. Each of the plurality of battery modules 52 comprises a housing and a plurality of battery cells (see FIGS. 3A-3B) provided within the housing, such as, for example, a plurality of lithium battery cells. In some instances, the battery 55 is provided in connection with a ground power 53.

Power is provided from the engine driven generator 54 or from the plurality of battery modules 52 via one or more voltage feed lines 58. In some examples, the voltage feed lines 58 are flexible high-voltage feed lines. Bus feeders 60 connect the voltage feed lines 58 to wing buses 62 within or coupled to the plurality of blades 22. In some alternative implementations, the battery 55 may be situated on (or integrated within) one or more wings of the aircraft 10.

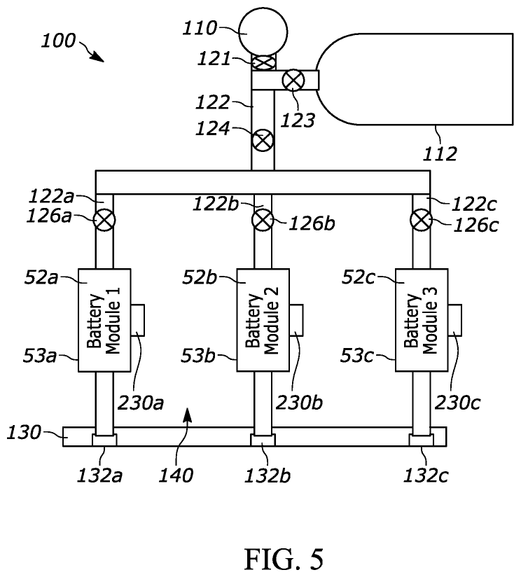

FIGS. 3A-3B illustrates a battery module 52 of the power supply system 50 according to some embodiments. The battery module 52 includes an inlet port 70 coupled to a conduit via an expansion nozzle 72 (described in more detail below), through which cooling fluid, fire suppressant, or both enter the battery module 52. The battery module 52 also includes an outlet port 74, coupled to a nozzle 132 (see FIGS. 5A-5B), through which a substance is vented from the battery module 52. The battery modules 52 of the illustrated embodiment include two rows 76a, 76b of approximately 200 battery cells 56, and each battery module 52 of the illustrated embodiment may have an output voltage of, for example, 800 V. Substance from the expansion nozzle 72 enters the battery module 52 through a primary channel 78. Each battery module 52 includes cell channels 73 (or gaps) between the plurality of battery cells 56 through which the substance flows. The battery module 52 also includes baffles (not shown) configured to direct fluids through the cell channels 73. Accordingly, the baffles ensure that sufficient cooling fluid contacts each battery cell 56. The battery cells 56 may be in a cell casing 75, such as, for example, a metal casing, and integrated cooling fins (not shown) may be provided on the cell casing 75, or on the battery cells 56 themselves, to provide a heat sink for the battery cells 56 and increase the surface area of the battery cells 56 that is exposed to a substance flowing through the battery 55. The integrated cooling fins may comprise a corrugated panel, which may be constructed of steel.

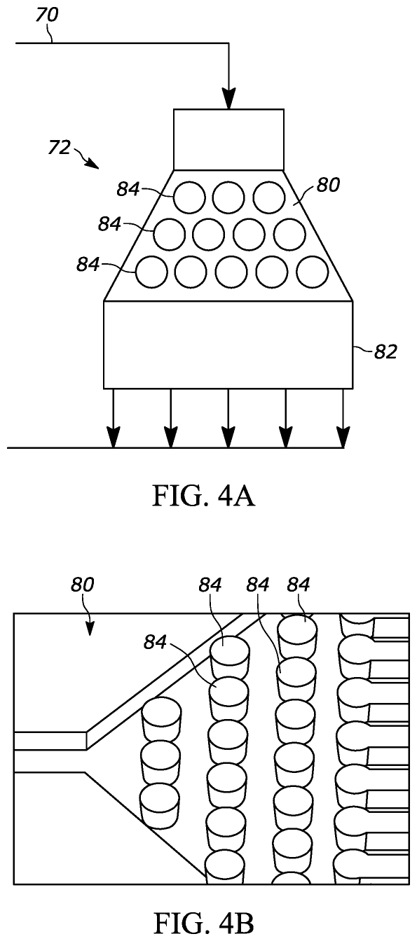

FIGS. 4A-4B illustrate a cross-section of the expansion nozzle 72. In some instances, the conduit 70 is a high pressure pipe having a relatively small cross sectional area. The expansion nozzle 72 receives the substance from the conduit 70 allows the substance to expand (suing expansion portion 80), thereby cooling the substance (according to the ideal gas law). The expanded substance exits an outlet port 82 of the expansion nozzle 72 and enters primary channel 78, contacting the battery cells 56 through both the primary channel 78 and the cell channels 73.

To maintain a uniform velocity of the substance at both ends of the expansion nozzle 72 (e.g., the conduit 70 and the outlet port 82), the expansion portion 80 includes a plurality of turning vanes 84 that direct flow of the substance. In some instances, the outlet port 82 includes a number of turns that the substance travels prior to the substance entering the primary channel 78. For example, the outlet port 82 may include a 90° turn such that the substance is provided to the primary channel 78 at a right angle. As another example, the outlet port 82 includes a plurality of 180° turns for the substance to travel before being provided to the primary channel 78.

In some embodiments, the battery modules 52 are designed with a high power to weight ratio and for use over a short duration (for example, approximately 30 to 40 seconds). To manage this high-power output of the battery 55 and to allow the battery 55 to operate and provide power for a controlled landing or other operation, the aircraft 10 includes a battery thermal management system that provides cooling, fire suppression, or both to the battery 55. FIG. 5 illustrates a battery thermal management system 100 for providing cooling and fire suppression to the battery 55 according to some embodiments. Although the battery thermal management system 100 is described herein as providing both cooling and fire suppression, in some embodiments, the battery thermal management system 100 may only provide one of these features.

As illustrated in FIG. 5, the battery thermal management system 100 includes a first storage vessel 110 and a second storage vessel 112, both of which are in fluid communication with the plurality of battery modules 52 via a conduit 122. Both the first storage vessel 110 and the second storage vessel 112 contain cooling fluids or fire suppression substances. For example, the first storage vessel 110 may contain a pressurized cooling fluid (also referred to herein as a cooling propellant), while the second storage vessel 112 contains a fire suppressant. The pressurized cooling fluid may comprise a foam, a baking soda suppressant, aircraft fuel, copper, one or more inert gases, such as, for example, liquid-state carbon dioxide, or other types of chemical coolants tailored to the chemical composition of the battery cells included in the battery 55. In some embodiments, the pressurized cooling fluid is an inert gas compressed to a liquid state. The fire suppressant may include a lithium fire suppressant, a carbon dioxide fire suppressant, a wet chemical fire suppressant, or another type of fire suppressant tailored to the chemical composition of the battery 55. In some embodiments, the fire suppressant is pressurized within the second storage vessel 112. In other embodiments, the fire suppressant is mixed with and subsequently propelled by the cooling fluid.

In alternative embodiments, the battery thermal management system 100 may only include the first storage vessel 110, and, thus, may only provide a cooling propellant. However, in some embodiments, the first storage vessel 110 may include a mixture of a cooling fluid and a fire suppressant. Accordingly, as used herein, the term “substance” includes a pressurized cooling fluid, a fire suppressant, or a combination thereof. Additionally, in alternative embodiments, rather than including a single first storage vessel 110 and a single second storage vessel 112, as illustrated in FIG. 5, the system 100 may include a plurality of vessels containing a cooling fluid, a plurality of vessels containing a fire suppressant, or a combination thereof. For example, the battery thermal management system 100 may include five vessels containing cooling fluids and two vessels containing fire suppressant. In embodiments where multiple vessels are used, the vessels may be used in parallel or in a serial fashion wherein, after a vessel is completed, an alternative vessel is controlled to provide the respective substance.

In the illustrated embodiment, the plurality of battery modules 52 includes a first, second, and third battery module 52a, 52b, 52c. The conduit 122 splits into first, second, and third connecting portions 122a, 122b, 122c for connecting the first storage vessel 110 and the second storage vessel 112 to the first, second, and third battery module 52a, 52b, 52c, respectively. The three battery modules 52a, 52b, and 52c are shown as an example embodiment. In other embodiments, the battery thermal management system 100 may include fewer or more battery modules 52 and associated conduit connecting portions 122.

A first temperature sensor 230a, a second temperature sensor 230b, and a third temperature sensor 230c are associated with the first, second, and third battery modules 52a, 52b, 52c, respectively, for detecting a temperature of each respective battery module 52. For example, each temperature sensor 230 may be located adjacent to or within the respective battery module 52, may be located between battery modules 52, or may be otherwise situated in locations suitable for detecting a temperature of each battery module 52. As one example, the temperature sensors 230 are infrared photodetectors located along a length of a respective battery module 52 to detect heat between each battery cell. As another example, the temperature sensors 230 are thermocouples mounted to the middle of each battery cell. Additional sensors may be also included to detect other characteristics of the battery 55, individual battery modules, or both, as described below in more detail.

A first vessel valve 121 is provided on the conduit 122 for controlling a discharge rate of the cooling fluid from the first storage vessel 110. A second vessel valve 123 is provided on the conduit 122 for controlling a discharge rate of the fire suppressant from the second storage vessel 112. Accordingly, using the valves 121 and 123, the battery thermal management system 100 is configured to provide only cooling fluid, provide only fire suppressant, or provide a combination of cooling fluid and fire suppressant to a downstream section of the conduit 122. The first vessel valve 121, the second vessel valve 123, or both may be operated between a closed and an open position or may be operated in a closed position and a plurality of open positions to regulate the flow rate supplied to the conduit 122. For example, an amount of the cooling fluid, the fire suppressant, or a combination thereof provided through the conduit 122 may be dependent on how open the first vessel valve 121 and the second vessel valve 123 are (e.g., an amount of actuation of the first vessel valve 121 and an amount of actuation of the second vessel valve 123).

As illustrated in FIG. 5, in some embodiments, the battery thermal management system 100 also includes a system valve 124 that may operate as a master valve for the system 100 and may be opened and closed to allow or stop flow of substances from both the first storage vessel 110, the second storage vessel 112 from reaching the battery modules 52. For example, in some embodiments, the system valve 124 may be operated to respond to faults in the first vessel valve 121, the second vessel valve 123, or both or may be used to provide further control over substances flowing to the battery modules 52 (e.g., separate from the vessel valves 121 and 123). It should be understood that, in some embodiments, the system valve 124 is not used, and the first vessel valve 121 and the second vessel valve 123 are controlled to allow or stop substance flow into the battery 55. It should be also understood that in some embodiments, the battery thermal management system 100 may include additional or fewer valves than those illustrated in FIG. 4 and the number and configuration of valves illustrated in FIG. 4 are provided as one example embodiment.

First, second, and third module valves 126a, 126b, 126c (collectively referred to herein as the module valves 126) are provided on the first, second, and third connecting portions 122a, 122b, 122c, respectively, for controlling an amount of substance flowing into the first, second, and third battery modules 52a, 52b, 52c, respectively. For example, both the first vessel valve 121 and the first module valve 126a may be opened to provide propellant coolant to the first battery module 52a without providing propellant coolant to the second and third battery modules 52b, 52c. In some embodiments, the module valves 126 may be configured to independently regulate the flow rate of the substance to a particular battery module 52. As one example, a substance may be provided to the first battery module 52a at a first flow rate and provided to the second battery module 52b at a second flow rate lower than the first flow rate by independently controlling the first module valve 126a and the second module valve 126b such that the first module valve 126a is further open than the second module valve 126b. The flow rate of the substance to each battery module 52 may be set using a combination of both the first vessel valve 121, the second vessel valve 123, or both and the respective module valves 126. Regulation of the flow rate of the cooling fluid or fire suppressant may entail modulating the flow rate to sustain cold gas temperatures over the duration of use of the substance.

The first vessel valve 121, the second vessel valve 123, the system valve 124, and the modules valves 126 may be configured as gate valves, globe valves, pinch valves, butterfly valves, poppet valves, ball vales, rotary valves, or other similar types of valves. In some instances, the first vessel valve 121, the second vessel valve 123, the system valve 124, and the modules valves 126 are each configured as the same valve type. In other instances, the first vessel valve 121, the second vessel valve 123, the system valve 124, and the modules valves 126 are each configured as different valve types or a combination of similar valves and different valves.

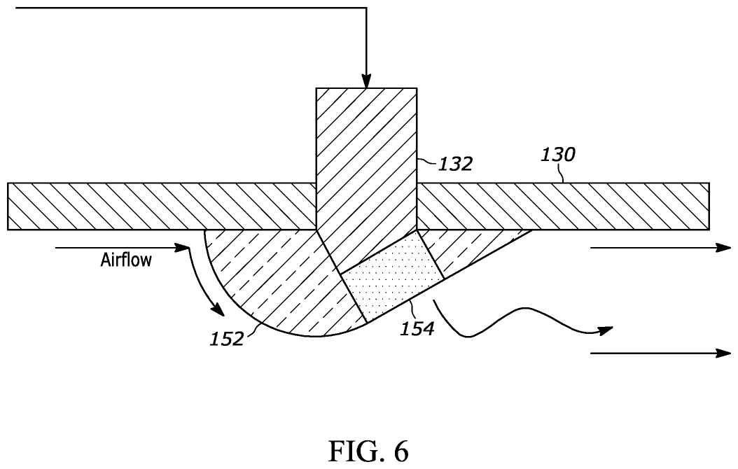

Each battery module 52 is in fluid communication with an environment exterior to the aircraft 10 via a venting system. With respect to the battery thermal management system 100 illustrated in FIG. 5, the venting system includes one or more nozzles, such as, for the embodiment illustrated in FIG. 5, first, second, and third nozzles 132a, 132b, 132c (collectively referred to herein as the nozzles 132). The nozzles 132, shown in more detail in FIG. 6, extend to and through a surface 130 of the aircraft 10 and are configured to direct substances away from the exterior (for example, an outer skin 152) of the aircraft 10. In some embodiments, the nozzles 132 define holes in the surface 130 that are closed via one or more pressure-mounted plugs 154, which may, when installed, be flush with the exterior of the surface 130. The pressure-mounted (or pressure-regulated) plugs 154 are configured such that the pressure-mounted plugs are forced open when a pressure within the respective battery module 52 exceeds a pressure of the external environment, but less than the pressure of the first storage vessel 110 and/or the second storage vessel 112. When the pressure-mounted plugs 154 open, the substances flowing through the battery modules 52 exit through the nozzles 132 and are directed away from the aircraft 10. In some embodiments, the pressure-mounted plugs 154 are configured such that they close and re-seal the hole when the pressure within the battery modules 52 drops below the pressure of the external environment. In other instances, the pressure-mounted plugs 154 are expelled away from the aircraft 10 when forced open. The holes in the surface 130 may be aft and downward facing such that the pressure at the nozzle 132 is less than the ambient pressure, even when the first storage vessel 110 and the second vessel 112 are empty, ensuring remaining gases continue to be drawn out through the hole rather than being expelled towards the cabin of the aircraft 10.

In some instances, the outer skin 152 is composed of a high temperature material. Additionally, the outer skin 152 may include a vertical offset such that it convects hot gases away from the surface 130, providing an additional layer of thermal conductive insulation.

Accordingly, the first, second, and third nozzles 132a, 132b, 132c are configured to vent the substance surrounding the first, second, and third battery modules 52a, 52b, 52c, respectively, in the presence of excess pressure within the battery modules 52. For example, in response to a battery cell (not shown) within the first battery module 52a catching fire and releasing gases that increase the pressure within the first battery module 52a above a pressure threshold of the pressure-mounted plug, the plug is expelled and the first nozzle 132a allows the gases (and any other substances flowing through the first battery module 52a) to vent from the battery 55 and away from the exterior surface of the aircraft 10. Similarly, in response to a substance provided by the battery thermal management system 100 increasing the pressure within the first battery module 52a above a pressure threshold of the pressure-mounted plug, the plugins expelled and the first nozzle 132a allows the substance to vent from the battery 55 and away from the exterior surface of the aircraft 10. Accordingly, in some embodiments, the battery thermal management system 100 is a one-shot system where cooling fluids, fire suppressants, gases, or a combination thereof are expelled rather than recirculated.

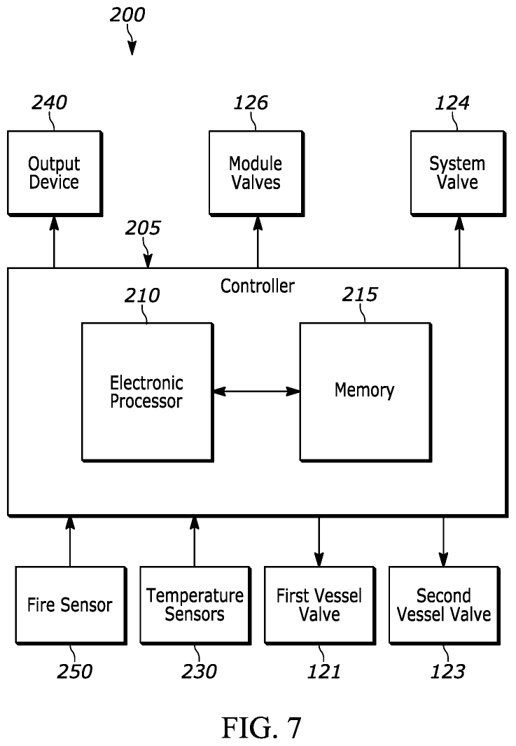

To control actuation of the first vessel valve 121, the second vessel valve 123, the system valve 124, and the modules valves 126, a control system 200 is included in the battery thermal management system 100, an example of which is illustrated in FIG. 7. The control system 200 includes a controller 205, one or more temperature sensors 230, optionally, one or more fire detection sensors 250, and, optionally, an output device 240. The temperature sensors 230 include the first temperature sensor 230a, the second temperature sensor 230b, and the third temperature sensor 230c. As illustrated in FIG. 7, the controller 205 communicates with the module valves 126, the first vessel valve 121, and the second vessel valve 123. The module valves 126 include the first module valve 126a, the second module valve 126b, and the third module valve 126c.

The controller 205 includes one or more microprocessors, digital signal processor, customized processors, field programmable gate arrays (FPGAs), or a combination thereof, and unique stored program instructions (including both software and firmware) that controls the one or more processors to implement, in conjunction with certain non-processor circuits, the functionality described herein or a portion thereof. Alternatively, the functionality described herein, or a portion thereof, could be implemented by a state machine that has no stored program instructions, or in one or more application specific integrated circuits (ASICs), in which functionality is implemented as custom logic. Of course, a combination of the two approaches could be used.

As illustrated in FIG. 7, in one embodiment, the controller 205 includes an electronic processor 210 (such as a programmable electronic microprocessor or similar device) and a memory 215. The electronic processor 210 executes instructions (software) to control operation of the battery thermal management system 100. The memory 215 is a non-transitory, machine-readable memory, such as a hard disk, an optical storage device, a magnetic storage device, a read-only memory (ROM), a programmable read-only memory (PROM), a random access memory (RAM), an electrically erasable programmable read-only memory (EEPROM), and a Flash memory. The memory 215 stores software executable by the electronic processor 210 to perform the control functionality and associated methods described herein.

As illustrated in FIG. 7, in some embodiments, the memory 215 stores instructions that, when executed by the electronic processor 210, identify which of the system valve 124, first module valve 126a, second module valve 126b, the third module valve 126c, the first vessel valve 121, the second vessel valve 123, or a combination thereof to open (or an amount of actuation of the respective valves) based on detected characteristics of the respective battery modules. In some instances, the instructions, when executed by the electronic processor 210, also identify how long to open each of the valves.

The optional output device 240 may include a display, speaker, gauge, dial, indicator, tactile output, or the like that provides information to a user as controlled by the controller 205. The output device 240 may be a dedicated device for the battery thermal management system 100 or an output device 240 included in the aircraft 10 for other purposes, wherein the controller 205 may communicate with the output device 240 via a wireless connection, a wired connection, or a combination thereof. The controller 205 may be configured to use the output device 240 to provide information to a user regarding an operating state or health state of the battery thermal management system 100. For example, in response to a temperature sensor 230 measuring a temperature within a respective battery module 52 that exceeds a temperature threshold, the controller 205 provides an alert indicative of the measured temperature via the output device 240 exceeding the temperature threshold. The output device 240 may also be used to provide a status of the battery thermal management system 100 during a preflight system check.

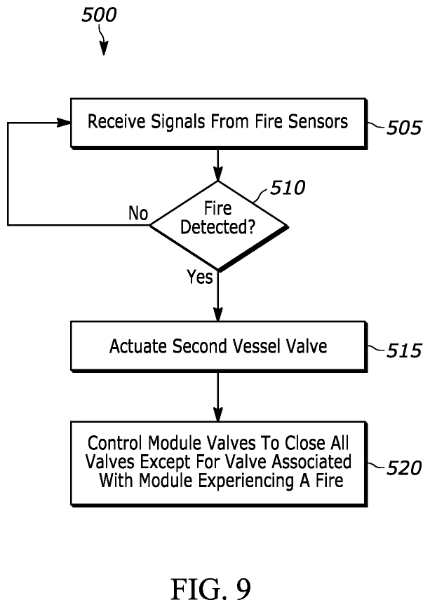

The optional one or more fire detection sensors 250 provide signals indicative of the presence or absence of a fire to the controller 205. The fire detection sensors 250 may include a smoke detector, such as, for example, an optical smoke detector, an ionization smoke detector, or an aspirating smoke detector, a gas detector, or a combination thereof. In some embodiments, each battery module 52 may be associated with a fire detection sensor 250 that is configured to detect a fire within the battery module. As described in more detail below with respect to FIG. 9, the controller 205 may control actuation of the system valve 124, first module valve 126a, second module valve 126b, the third module valve 126c, the first vessel valve 121, the second vessel valve 123, or a combination thereof in response to detection of a fire in a battery module 52. In some embodiments, the temperature sensors 230 are used to detect fires, such as by detecting a temperature level associated with a fire, without the need for one or more fire detection sensors.

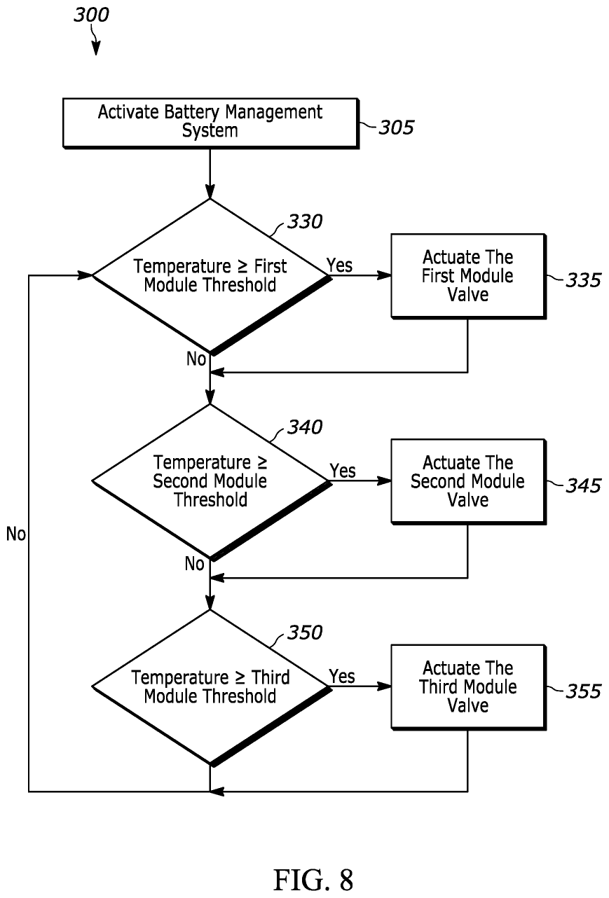

FIG. 8 illustrates a method 300 for controlling one or more valves of the battery thermal management system 100 according to an example embodiment. The method 300 is described as being executed by the controller 205 (for example, through the execution of instructions by the electronic processor 210). However, in some examples, aspects of the method 300 are performed by another device. For example, the functionality of the controller 205 may be distributed among multiple controllers included in the aircraft 10, among multiple controllers external to but communicatively coupled to the aircraft 10, or a combination thereof. For example, the functionality described herein as being performed by the controller 205 may be distributed among a plurality of controllers 205, such as, for example, a master controller and a local controller associated with each module valve 126. Additionally, while the steps of method 300 are illustrated as being conducted successively, certain steps may instead be performed concurrently or in a different order. Additionally, while a specific order of steps is illustrated, in some embodiments, steps may be performed in a different order.

As illustrated in FIG. 8, the method 300 includes activating the battery thermal management system 100 (at block 305). In some instances, the battery thermal management system 100 is activated in response to a detected condition. For example, in response to detecting a failure or performance issue of the engine driven generator 54, a pilot may provide an input to the controller 205 to initiate operation of the battery 55 and the battery thermal management system 100. In other embodiments, the controller 205 automatically activates the battery thermal management system 100 in response to detecting an event, such as, for example, a particular operating state of the engine driven generator 54 or activation of the battery 55 (e.g., detecting a power output of the battery). To activate the battery thermal management system 100, the controller 205 may control the first vessel valve 121 and each of the module valves 126 to provide a default amount of cooling propellant to the battery modules (e.g., by actuating each of the first vessel valve 121 and the modules valves 126 to an open position) (at block 305).

After activating the battery thermal management system 100, the controller 205 receives temperature signals from the temperature sensors 230 indicative of temperatures of the battery modules 52, and the controller 205 determines whether any of the temperature signals received from the temperature sensors 230 indicate a temperature exceeding a temperature threshold.

For example, using an example embodiment where the battery 55 includes three battery modules 52, the controller 205 determines which battery modules 52 are experiencing a temperature above a temperature threshold. In the example of FIG. 8, the controller 205 determines whether a temperature of the first battery module 52a exceeds a first module threshold (at decision block 330), such as, for example, by comparing a received temperature signal from the temperature sensor associated with the first battery module 52a to the first module threshold (e.g., a first temperature threshold). In response to the temperature of the first battery module 52a exceeding the first module threshold, the controller 205 actuates the first module valve 126a to increase an amount of cooling propellant provided to the first battery module 52a (at block 335). Similarly, the controller 205 determines whether a temperature of the second battery module 52b exceeds a second module threshold (at block 340). In response to the temperature of the second battery module 52b exceeding the second module threshold (e.g., a second temperature threshold), the controller 205 actuates the second module valve 126b to increase an amount of cooling propellant provided to the second battery module 52b (at block 345). The controller 205 also determines whether a temperature of the third battery module 52c exceeds a third module threshold (at block 350). In response to the temperature of the third battery module 52c exceeding the third module threshold (e.g., a third temperature threshold), the controller 205 actuates the third module valve 126c to increase an amount of cooling propellant provided to the third battery module 52c (at block 355).

As illustrated in FIG. 8, the controller 205 may repeat this process to continue adjusting an amount of cooling propellant provided to each battery module 52 during operation of the battery 55 (through adjusting a position of one or more valves through valve actuation or control). In some embodiments, the controller 205 is also configured to adjust a position of the first vessel valve 121 during this temperature monitoring process. For example, in response to one or more of the battery modules 52 experiencing a temperature exceeding an associated threshold, the controller 205 may control the first vessel valve 121 to increase an amount of cooling propellant available to the battery modules 52. For example, in some embodiments, in response to one or more of the module valves 126 being opened to a maximum amount, the controller 205 may control the first vessel valve 121 to increase an overall amount of cooling propellant available to the battery modules 52. Similarly, in some embodiments, the controller 205 may be configured to control the first vessel valve 121, the module valves 126, or both to decrease an amount of cooling propellant provided, such as, for example, in response to a received temperature signal indicating a temperature falling below a particular threshold. Decreasing a flow or distribution rate of the cooling propellant may preserve an amount of cooling propellant available to the battery 55 and help ensure that cooling is provided for an operational duration of the battery 55.

As noted above, in some embodiments, each battery module 52 may have a respective threshold that is used by the controller 205 to control the opening (and closing) of the associated module valve 126. These thresholds may be the same for each module or may differ, such as, for example, based on a position or characteristic of a particular module 52. Also, in some embodiments, each battery module 52 may be associated with a plurality of thresholds, wherein each threshold corresponds to a different position of a module valve 126. For example, when a particular battery module 52 exceeds a particular temperature threshold, the controller 205 may control the module valve 126 of the battery module 52 to a particular open position (from among a plurality of available open positions, such as, for example, 25% open, 50% open, 75% open, or 100% open) corresponding to the threshold.

As also noted above, each of the module valves 126 can be controlled independently to allow different amounts of cooling propellant be applied to different battery modules 52 and, hence, respond to varying temperatures experienced by the battery modules 52. This independent controls allows the controller 205 to preserve cooling propellant and help ensure that cooling propellant is available for the operational duration of the battery 55 (e.g., during a controlled landing operation). It should be understood, however, that, in some embodiments, the module valves 126 may be controlled as a group, wherein the control may be based on any one of the battery modules 52 experiencing a particular temperature.

As further noted above, in some embodiments, a cooling propellant is provided (through actuation of the first vessel valve 121) during operation of the battery 55, such as, for example, in response to the battery 55 being put into use. In other embodiments, the controller 205 may not start providing cooling propellant during operation of the battery 55 until one or more of the battery modules 52 experiences a particular temperature exceeding a threshold. Similarly, in some embodiments, the controller 205 may be configured to start providing cooling propellant in response to a sensed temperature from a temperature sensor associated with the battery 55 in general (as compared to a particular battery module 52). Accordingly, it should be understood that the controller 205 may start providing cooling propellant in response to various triggers and such triggers may be set as part of configuring the battery thermal management system 100 for the aircraft 10.

As noted above, in some embodiments, the battery thermal management system 100 also includes a second storage vessel 112 containing a fire suppressant. In these embodiments, the controller 205 may also be configured to control the second vessel valve 123 to control an amount (if any) of fire suppressant provided to one or more of the battery modules. For example, FIG. 9 illustrates a method 500 for operating the control system 200 and, in particular, a method of controlling one or more valves of the battery thermal management system 100 to provide a fire suppressant to one or more of the battery modules 52. The method 500 is described as being executed by the controller 205 (e.g., through execution of instructions by the electronic processor 210). However, in some examples, aspects of the method 500 are performed by another device. For example, the functionality of the controller 205 may be distributed among multiple controllers included in the aircraft 10, among multiple controllers external to but communicatively coupled to the aircraft 10, or a combination thereof. For example, the functionality described herein as being performed by the controller 205 may be distributed among a plurality of controllers 205, such as, for example, a master controller and a local controller associated with each module valve 126. Additionally, while the steps of method 500 are illustrated as being conducted successively, certain steps may instead be performed concurrently or in a different order. Additionally, while a specific order of steps is illustrated, in some embodiments, steps may be performed in a different order.

As illustrated in FIG. 9, the controller 205 receives signals from the one or more fire detection sensors 250 (at block 505). The controller 205 determines, based on the signals from the one or more fire detection sensors 250, whether a fire is detected within the battery 55 (at block 510). In response to detecting a fire based on the received signals (at block 510), the controller 205 actuates the second vessel valve 123 (at block 515), which allows the fire suppressant stored in the second storage vessel 112 to flow through the conduit 122. In some embodiments, the controller 205 actuates the second vessel valve 123 (at block 515) to a fully open position to ensure the fire suppressant reaches the detected fire quickly and effectively. Similarly, in some embodiments, the controller 205 adjusts a position of one or more of the module valves 126 in response to detecting a fire. For example, the controller 205 may actuate each module valve 126 to be in a fully open position to allow the fire suppressant to reach the detected fire quickly and effectively. Also, as noted above, in some embodiments, the fire suppressant is provided along with the cooling propellant (e.g., to use the propelling nature of the cooling propellant to push the fire suppressant through the battery 55). Accordingly, in some embodiments, the controller 205 may be configured to, in response to detecting a fire, adjust a position of the first vessel valve 121, such as, for example, actuating the first vessel valve 121 to a fully open position. In other embodiments, the fire suppressant may be provided separate from the cooling propellant and, in this embodiment, the controller 205 may be configured to close the first vessel valve 121 in response to detecting a fire.

In some embodiments, while capable of suppressing fires, the fire suppressant stored in the second storage vessel 112 may cause damage to battery module or a portion thereof. Accordingly, in some instances, the second vessel valve 123 is controlled to provide fire suppressant only when a fire is detected and also, in some embodiments, the fire suppressant is only provided to a battery module 52 experiencing a fire. For example, as described above, each battery module 52 may be associated with a fire detection sensor 250 configured to detect a fire within the battery module 52. Accordingly, the controller 205 uses the signals from the fire detection sensors 250 to detect whether a fire is occurring and also to identify which battery module 52 is experiencing a fire. For example, as illustrated in FIG. 7, in some embodiments, the controller 205 is configured to, in response to detecting a fire, control the module valves 126 such that the module valve 126 associated with battery module 52 experiencing a fire is open (e.g., in a fully open position) while the other module valves 126 are closed (at block 520).

In some embodiments, the controller 205 keeps the second vessel valve 123 open until a fire is no longer detected based on the signals from the fire detection sensors. In this embodiment, in response to a fire no longer being detected, the controller 205 may close the second vessel valve 123 and open the first vessel valve 121 and the plurality of module valves 126 to return to a cooling process as described above with respect to FIG. 8. In other embodiments, the controller 205 may be configured to the second vessel valve 123 open after a fire is detected to ensure that the fire (and any subsequent fires) is distinguished and recognizing that the fire detection sensor 250 associated with the battery module 52 experiencing a fire may become damaged and may not be able to provide accurate information regarding whether the fire has been extinguished. While providing fire suppressant, the controller 205 may continue monitor signals received from the fire detection sensors 250 and, in response to detecting another fire in a different battery module 52, may open the module valve 126 associated with the different battery module 52 to allow the fire suppressant to flow to each battery module 52 experiencing a fire. As noted above, in some embodiments, rather than using the fire detection sensors 250, the controller 205 may be configured to use temperatures detected by the temperature sensors 230 to detect fires, such as by performing the method 500 in response to detecting a temperature of a battery module 52 exceeding a fire threshold. Also, in some embodiments, a fire may be detected using a thermo-mechanical system. The thermo-mechanical system may include one or more components, such as, for example, a wire, that exposed to a particular temperature (including a temperature associated with a fire) experiences a thermal deformation (such as, for example, a wire melting and breaking an electrical connection, the breaking of a mechanical connection, or the like). These changes may consequently open the second vessel valve 123 (through a mechanical or electrical response or via the controller) to provide fire suppression as described above. Such a thermo-mechanical system may be used to detect fire as well as other situations, including, for example, high temperatures that may control the flow of the cooling propellant.

While embodiments described herein have primarily referred to a hybrid aircraft having both an engine and a battery, in some embodiments, the battery thermal management system 100 is implemented within aircrafts fully powered by a battery (e.g., electric aircraft). While a particular battery configuration has been provided an illustrated, the battery thermal management system 100 may also be implemented with other types of batteries and battery modules. Additionally, while embodiments described herein have primarily referred to providing cooling fluids and/or fire suppressant to the battery 55 and battery modules 52, in some embodiments, the cooling fluid and/or fire suppressant is provided to other components in the aircraft 10. For example, cooling fluid and/or fire suppressant may be provided to the engine driven generator 54. By using the cooling fluid and/or fire suppressant in other portions of the aircraft, components are fully utilized, reducing the weight of the aircraft that may otherwise be used by redundant cooling systems. Further weight reductions are found in a casing storing the battery 55. For example, previous batteries used in aircrafts have required thick, fireproof casings to avoid further spread of the fire. As the battery thermal management system 100 handles cooling the battery 55 and suppressing any fires, a lightweight casing may instead be implemented.

Also, while embodiments described herein have referred primarily to providing cooling, fire suppression, or both in response to temperature monitoring, in some embodiments, other characteristics may be monitored (in addition to monitoring temperatures or as an alternative to monitoring temperatures) to determine whether to actuate a valve of the battery thermal management system 100. For example, the controller 205 may monitor a voltage output of the battery modules 52 using one or more voltage sensors. In response to the voltage output of the battery modules 52 dropping below a voltage threshold (indicating an increase in current draw), the controller 205 may increase cooling through activation of one or more valves as described above. Similarly, in some embodiments, the controller 205 monitors a current of the battery modules 52 using one or more current sensors, fuses, or both. In response to the current increasing above a current threshold (indicating a temperature increase), the controller 205 may increase cooling through activation of one or more valves as described above.

Additionally, while embodiments described herein have referred primarily to providing a substance via a conduit 122, in other embodiments, the plurality of battery cells 56 are submerged in a liquid to cool the plurality of battery cells 56. For example, in response to a temperature associated with the plurality of battery cells 56 exceeding a temperature threshold, the battery cells 56 may be submerged in a liquid. The liquid may be, for example, water, a fuel, or the like.

In some embodiments, as an alternative in addition to pressurized cooling fluid, the cooling fluid may include a misted liquid (e.g., a fine droplet mist). Other suitable purposed coolants may be used. In some instances, rather than pressurized storage vessels 110, 112, the cooling system itself (e.g., downstream components connected to the conduit 122) is pressurized to force a substance from one or both of the storage vessels 110, 112 to the plurality of battery modules 52.

Various features and advantages of the embodiments described herein are set forth in the following claims.

What is claimed is:

1. An aircraft comprising:
a plurality of battery modules, each battery module of the plurality of battery modules including a housing; and
a battery thermal management system including:
a storage vessel containing a cooling propellant,
a conduit fluidly coupling the storage vessel to an interior of the housing of each the plurality of battery modules,
a vessel valve controlling a flow rate of the cooling propellant from the storage vessel to the conduit, and
a venting system including:
one or more nozzles extending to an exterior of the aircraft and in fluid communication with the interior of the housing of each of the plurality of battery modules, the one or more nozzles directing the cooling propellant to the exterior of the aircraft.

2. The aircraft of claim 1, wherein the battery thermal management system further includes a plurality of module valves, each module valve associated with a different one of the plurality of battery modules.

3. The aircraft of claim 1, wherein the battery thermal management system further includes a second storage vessel containing a fire suppressant.

4. The aircraft of claim 1, wherein the battery thermal management system further includes an expansion nozzle coupled between the conduit and the housing of each of the plurality of battery modules, wherein the expansion nozzle is configured to reduce a temperature of the cooling propellant.

5. The aircraft of claim 1, wherein the cooling propellant is an inert gas compressed to a liquid state.

6. The aircraft of claim 1, wherein each of the plurality of battery modules includes:
a plurality of battery cells; and
baffles configured to direct the cooling propellant through gaps between each of the plurality of battery cells.

7. The aircraft of claim 1, wherein each of the plurality of battery modules includes:
at least one battery cell;
at least one cell casing for containing the at least one battery cell; and
at least one integrated cooling fin provided on the at least one cell casing.

8. The aircraft of claim 1, wherein the storage vessel contains a mixture of a fire suppressant and the cooling propellant.

9. The aircraft of claim 1, wherein the venting system further includes one or more plugs pressure-mounted in one or more holes defined by the one or more nozzles.

10. The aircraft of claim 1, wherein the battery thermal management system further includes:
a temperature sensor configured to sense cell temperatures in the plurality of battery modules, and
a controller configured to:
receive, from the temperature sensor, a signal indicative of a cell temperature in a first battery module of the plurality of battery modules, and
adjusting, in response to the cell temperature exceeding a predetermined temperature, a position of a first module valve associated with the first battery module, the first module valve independently controllable from a second module valve associated with a second battery module of the plurality of battery modules.

11. A battery thermal management system for a plurality of battery modules within an aircraft, the battery thermal management system including:
a storage vessel containing a cooling propellant;
a conduit fluidly coupling the storage vessel to the plurality of battery modules;
a vessel valve controlling a flow rate of the cooling propellant from the storage vessel to the plurality of battery modules through the conduit;
a sensor configured to monitor a condition of one or more of the plurality of battery modules;
a venting system configured to selectively permit fluid communication between the plurality of battery modules and an exterior of the aircraft; and
a controller communicatively coupled to the vessel valve and the sensor, the controller configured to control the vessel valve based on the condition of the one or more of the plurality of battery modules.

12. The battery thermal management system of claim 11, wherein the sensor is a temperature sensor.

13. The battery thermal management system of claim 12, wherein the controller is configured to control the vessel valve by actuating, in response to a cell temperature in one of the plurality of battery modules sensed by the temperature sensor exceeding a predetermined temperature, the vessel valve to an open position.

14. The battery thermal management system of claim 11, wherein the controller is configured to provide, to an output device, an output indicative of the condition of the plurality of battery modules.

15. The aircraft of claim 11, wherein each of the plurality of battery modules includes:
a plurality of battery cells; and
baffles configured to direct the cooling propellant through gaps between each of the plurality of battery cells.

16. The aircraft of claim 1, wherein each of the plurality of battery modules includes:
at least one battery cell;
cell casings for containing each battery cell; and
integrated cooling fins provided on each cell casing.

17. A method of managing a plurality of battery modules aboard an aircraft, the method comprising:
actuating, with a controller, a first vessel valve to an open position, the first vessel valve in fluid communication with a first storage vessel containing a cooling propellant and the plurality of battery modules through a conduit;
monitoring, with the controller, a temperature corresponding to one or more of the plurality of battery modules;
actuating, with the controller in response to the temperature of a first battery module of the plurality of battery modules exceeding a predetermined temperature, a first module valve associated with the first battery module and in fluid communication with the first vessel valve to a first position, the first module valve independently controllable from a second module valve associated with a second battery module of the plurality of battery modules;
detecting, with the controller, a fire in the second battery module of the plurality of battery modules; and
in response to detecting the fire:
actuating, with the controller, the first module valve to a closed position,
actuating, with the controller, a second vessel valve to an open position, the second vessel valve in fluid communication with a second storage vessel containing a fire suppressant and the plurality of battery modules through the conduit.

18. The method of claim 17, wherein detecting the fire includes detecting the fire based on a signal from a fire detection sensor.

19. The method of claim 17, further comprising, in response to detecting the fire, actuating the first vessel valve to a closed position.

20. The method of claim 17, wherein the predetermined temperature includes a first predetermined temperature and further comprising actuating, with the controller in response to the temperature of the first battery module exceeding a second predetermined temperature, the first module valve to a second position to increase an amount of cooling propellant provided to the first battery module.
